(19) United States
(12) Patent Application Publication
(10) Pub. No.: US 2004/0143852 A1
(43) Pub. Date: Jul. 22, 2004

(54) Systems and methods for massively multi-player online role playing games

(76) Inventor: Philip G. Meyers, Flower Mound, TX (US)

Correspondence Address: Philip G. Meyers, Philip G. Meyers Law Office, Suite 302, 1009 Long Prairie Road, Flower Mound, TX, 75022, US

(21) Appl. No.: 10/754,069

(22) Filed: Jan. 8, 2004

Related U.S. Application Data
(60) Provisional application No. 60/438,695, filed on Jan. 8, 2003.

(51) Int. Cl. H04N 7/173; G06F 19/00; G06F 17/00; A63F 13/00; A63F 9/24; H04N 7/16

(52) U.S. Cl. 725/133; 725/141; 463/1; 463/43; 463/40; 463/42

(57) ABSTRACT

A MMORPG according to the invention contains one or more features designed to reduce game predictability, increase the variety of activities a player can pursue, and enhance player versus player experience. Such features include a hybrid MMORPG with both persistent and non-persistent areas, limited access areas, player controlled areas, multiple types of creature spawns, object spawns, player-controlled or programmed NPC's, one time world events, programmed “botting” of player characters, creature effects on environment, simulated artificial intelligence for NPC's dialogs, non-experience based leveling, database driven randomly generated quests, non-experienced based leveling, user-programmable sound effects, database-driven randomly generated encounters, alignment in an MMORPG, temporary NPC companions, formations for purposes of temporary character collision detection, special effect sites, dueling, player apprentices, special purpose guilds, multiplayer emotes, multiple tier server realms, mini-battlegrounds, limited player access areas, PvP battlegrounds with access limited by player population, and terrain based stealth and hiding abilities. These can be used in combination to provide a more interesting MMORPG game experience.

This application claims priority of U.S. provisional application Serial No. 60/438,695, filed Jan. 8, 2003.

### TECHNICAL FIELD

The invention relates to computerized systems for online computer gaming, specifically for use in multiplayer online games.

### BACKGROUND OF THE INVENTION

MMORPG's, or massively multiplayer online role playing games, have been in existence for several years. Current examples include Everquest (EQ) and Dark Age of Camelot (DAOC), among others. These games share a common structure. A single large game session is run on a host computer or server. Players use local personal computers (PC's) to log into the server through the Internet and send commands controlling a player character to game system software running on the server. The player character is represented by an animated figure that moves on a map that represents the game world, generally a simulation of a three dimensional outdoor world with occasional indoor areas. The server is a common area in which all players move, and as such there may be thousands of players on that server all moving and taking actions in the same game session.

Currently available MMORPG's such as DAOC use game worlds divided into “zones” or areas in which the local PC loads a new set of game information for a region. An indoor area, such as a dungeon, is usually a separate zone from the adjoining outdoor area, and characters move from one to the other by moving to and from entrance areas. During “zoning”, the local PC loads data concerning the zone the player character is traveling to.

Many MMORPG's are in a fantasy setting, and as such much player time in the game is spent combating monsters or enemies and finding treasures dropped by these enemies. Since the game runs continuously with players coming and going at random, when creatures are killed or banished by a player, the map must repopulate itself DAOC has spawn locations at which replacement creatures will spontaneously appear, and then begin to move according to programmed patterns until a player character comes along to fight that creature. In some instances, the presence of a player character at a certain spawn location will prevent the creature from appearing for as long as the character remains. Some of these games provide creatures with limited artificial intelligence, for example, coming in groups rather than one at a time when attacked, or calling for help from others of its kind when close to death (hits points below a certain level).

These games represent computerized imitations of fantasy role playing games such as Dungeons and Dragons which are played face to face on a table top. The Internet now serves to allow players in remote places to get together, form groups or parties, adventure together, and form in-game guild organizations. However, while the software interfaces for these games continue to improve, the games themselves remain rudimentary. Characters gain experience to advance in level mainly by repetitive killing of enemies or creatures, which becomes tiresome even when done in parties or groups. Placing a large number of players into the same game at the same time creates problems of players competing to play in popular areas, resulting in overcrowding of some areas while others are permanently deserted. The present invention attempts to solve these and other problems with such games.

DAOC imposes an upper limit on 50 on level advancement. Upon reaching level 50, the leveling process ends and the character is expected to move on to the frontier areas set aside for player versus player combat. This is termed “realm vs. realm” in DAOC because all players from the same realm are teamed against players from the other two realms. The mechanics of player versus player (PvP) are different from so called player versus computer controlled enemies (PvE). In DAOC, PvE is mostly a means to get to PvP, and level 50 characters receive no benefit other than loot from continuing in PvE.

These games are by nature endless or open-ended. They continue on in a steady state except when software changes are made that change game content. At some point in the game's life, players come to know the map by heart and run out of new and interesting things to do. The companies offering these games receive a monthly user fee and are thus motivated to keep subscribers entertained for as long as possible. “Expansions” are developed for this purpose. An expansion is a subsequent software release that typically introduces new lands to explore and may offer other changes in content such as new character races or items. The content of the expansion becomes a permanent part of the game world, and later expansions add to it further. Expansions of this kind are, however, of less interest to players whose characters have already reached maximum level.

In the DAOC expansion Trials of Atlantis, so called “master levels” were introduced wherein level 50 characters are put back onto a leveling track and need to obtain master level 10 before gaining full benefit. The master levels are earned by completing a checklist of difficult encounters (mostly battles) for each master level. Unlike the normal leveling process, many of the master level encounters require a large group of players working together to be done successfully. The Atlantis expansion may be viewed as an attempt to extend DAOC's commercial life by adding yet more leveling activities to the game before a character can be considered fully competitive with those of opposing realms.

Presently offered MMORPG'S, whether in original or expanded form, are essentially static game worlds. The computer controlled game features respond to player actions in a robotic fashion, and the only unpredictable aspect of the game is the manner in which human-controlled player characters will interact. This creates a host of problems. The game tends to be repetitious, slow paced and a lot of time is wasted waiting around for other players to get ready to do something. The game system itself does not motivate players to role play, and indeed gives them little chance to do so.

In a table top RPG, a scenario is played once, and then the group moves on to other adventures, all under the guidance of a human game master. The present invention seeks to provide an improved online MMORPG that provides a more interesting and dynamic game environment. An essential goal of the present invention is to make the game content less predictable and more like the custom content one would expect from a human game master in a table top role playing game, while retaining a computer as the game's moderator rather than a human being. This may be termed “AC” or artificial creativity, akin to AI or artificial intelligence. It can be implemented in a number of ways, as discussed hereafter.

### SUMMARY OF THE INVENTION

A MMORPG according to the invention contains one or more features designed to reduce game predictability, increase the variety of activities a player can pursue, and enhance player versus player experience. Such features include a hybrid MMORPG with both persistent and non-persistent (temporary) areas, limited access areas, player controlled areas, multiple types of creature spawns, object spawns, player-controlled or programmed NPC's, one-time world events, programmed “botting” of player characters, creature effects on environment, simulated artificial intelligence for NPC dialogs, non-experience based leveling, database driven randomly generated quests, non-experienced based leveling system, user-programmable sound effects, database-driven randomly generated encounters, alignment in an MMORPG, temporary NPC companions, formations for purposes of temporary character collision detection, special effect sites, dueling, player apprentices, special purpose guilds, multiplayer emotes, multiple tier server realms, mini-battlegrounds, limited player access areas, PvP battlegrounds with access limited by player population, and terrain based stealth and hiding abilities. The invention further provides a number of other improvements as detailed below, which can be used in combination to provide a much more interesting MMORPG game experience. The methods of the invention are the corresponding methods of creating and/or using the game system having one or more of the improved features.

### BRIEF DESCRIPTION OF THE DRAWING

In the accompanying drawing:

FIG. 1 is a map of a three dimensional prior art dungeon area suitable for use as a game subsession according to the invention;

FIG. 2 is a schematic diagram of composite game world zones including player-moderated zones; and

FIG. 3 is a flow diagram of logic for generating an encounter area according to the invention.

### DETAILED DESCRIPTION

This description assumes a close familiarity with the current, widely known MMORPG game Dark Age of Camelot (DAOC) and online game Diablo2 (D2) played through an Internet-accessible server called battle.net, among others. In one aspect the invention contemplates the creation of game sub-sessions or hybrid MMORPG games. In non-MMORPG games such as Diablo2, the server runs a large number of separate game sessions in parallel. Each game session has the same map and will admit a small number of players (such as up to 8 at a time.) Any player on this service can start a new game session which can be open for others to join. MMORPG's are just the opposite, i.e., a single game session for all of the players on that server, rather than many small game sessions that run in parallel.

The invention in its first aspect combines a large server-based game (similar to DAOC or EQ) where players can interact, with small, player generated games as in D2. This is done by access through entry points to limited access areas that only one or a limited number of players or groups can enter at a time. “Groups” or “parties” are several players who have voluntarily formed a group for game purposes that the game control software recognizes. For example, player A forms a group with players B, C and D by issuing invite commands to each, which they then accept by issuing accept commands on their local PC's. The system then recognizes the group as players A, B, C and D and may recognize player A as leader. Each group that enters is alone in the dungeon, much like creating a game in D2. The game session disappears once all players have left the area, or when another condition is fulfilled, e.g. the player that created the sub-session logs off (leaves the game) and does not return in a specified period of time.

In such a hybrid-MMORPG according to the invention, the common zones such as large outdoor areas are open to all players, and while moving in this area, players can see other players moving about and interact with each other. In the limited access area, however, a new instance of the area is spawned (created) each time a solo player (not in a group) or group of players enters that area. There is no restriction on access per se, but each group entering will find itself alone in its own game subsession except for system controlled creatures. This makes it possible to make the limited access area more interesting in game content, with unique puzzles, traps and the like, as compared to the common area which may be little more than open terrain with spawned creatures and/or items and little more. The limited access area may be one that does not respawn in a typical manner, but is instead re-set each time created, in the manner of a level of D2. As such the limited access area can be cleared out as players work through it, and once empty players have reason to leave, rather than stay “camped” on enemies the respawn perpetually on the same location.

If player versus player (PvP) combat is permitted in the dungeon or other area which is the subject of a player-generated subgame, then a rival player or group of players may also be permitted to enter that subsession. In an environment such as DAOC where all players of a given realm are friendly to one another and hostile to members of the other two realms, then each subgame could be programmed to permit one player or group of each realm to enter. Order of entry can be random or in order of subgame creation (oldest pending game having only a single realm represented gets the next entering group from the rival realm.)

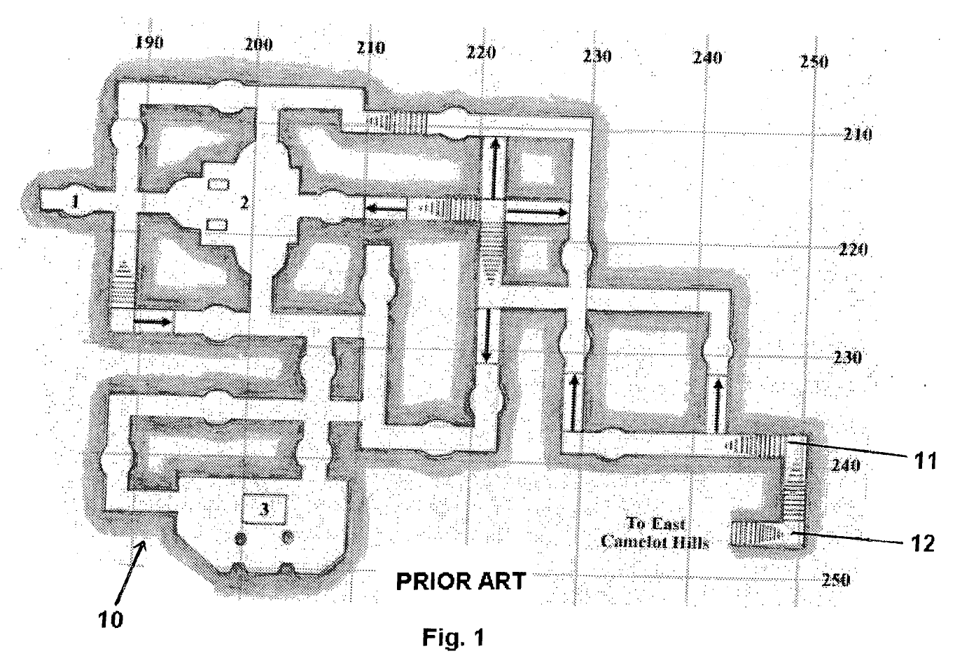

An example of an area suitable for subgame is a DAOC dungeon zone 10 such as shown in FIG. 1. The dungeon 10 has an entrance 11 and exit area 12. When a player enters the dungeon through a corresponding entrance area in the common world area, the player's character appears at area 11. The character then remains in the zone 10 until the player moves the character to exit 12, the characters dies, or another game event forces the player to exit the dungeon.

Unlike DAOC, according to the invention, the server does not maintain a single persistent dungeon 10, but rather spawns multiple dungeon game sessions, one each for each player or group of players that enters. These subgames or subsessions may run several at a time in the manner of games of D2. In a preferred form of the invention, each subgame can have a different floor plan or layout based on a random map generating algorithm or a series of geomorphic map sections that are recombined at random each time a subgame is created. This can be combined with randomly assigned, one time creature spawns and more elaborate tree-based encounter spawns as described hereafter to provide a less predictable adventure for the players, yet permitting the players to be part of a larger, persistent world.

A subsession that admits more than a single player will generally run on the server. According to a further variation of the invention, sub-areas of the map are generated locally on the player's PC. A player can enter these areas and explore them alone. Secret doors leading to secret areas are commonplace in tabletop fantasy role playing (FRP) games but seldom used in online games, perhaps because information about MMORPG worlds is widely published on the Internet, and a secret door would not be secret very long if it were a permanent map feature. Instead, local sub-areas can be randomly generated for each player at logon or when that player enters the zone in which that sub-area can be entered. The subgame areas cease to exist when the player leaves the game or the zone, whichever option is used, and new ones with new random entry points are created. A secret door can be used as an entry point to a local PC only area. Where other players find only a blank wall at that location on the common area map, the one player can pass through the wall and enter the area beyond.

Other forms of limited access areas may be incorporated into a persistent game world without the need to generate a series of parallel subgames. Currently DAOC maintains special battleground areas where only players within a certain level range can enter. Asheron's Call 2 (AC2) has proposed a system wherein keys will be used to limit the number of players able to gain entry to dungeon areas. According to another aspect of the invention, for purposes of the limited access area, when one single player or group enters the limited access zone, the entrance 11 is inactivated until that group has left the area. This solves the crowding problem, but may lead to fierce competition at such portals to be the next one in. To alleviate such concerns, entrance 11 could for example disappear and move to a new location each time a solo player or group enters, and optionally not reappear at the new location until open for a new player or group to enter. The Hill of Faerie, for example, is an underground dungeon area for which the entrance appears on the user's screen as a ring of mushrooms that intermittently or randomly disappears from its present location and randomly reappears in another, most likely within a certain map region. This applies only to the entrance to the area, and no thus no programming of multiple instances of the same area is then required. There may be ways for players to determine where the Hill is or where it will appear next. For example, questioning the non-player characters (NPC's) of nearby towns using the knowledge database described hereafter may reveal that the entrance was sighted nearby and may reveal the general direction. A player using specific skills such as divination or astrology may be able to predict the appearance or movement of the entrance.

At the game designer's option, players may not be allowed to “log” or save their game in a persistent limited access area, i.e., one that is always there and does not disappear in the manner of a game subsession as described above. Normally, upon issuing a command to quit the game, after a few seconds the player's character disappears from the game world. When the player returns to resume the game at a later time, the character reappears at the same location. In the case of a limited access area, a player that logs off reappears at another location, such as a bind point (place a player reappears after dying during the game), the entrance, or the nearest town or settlement. However, this can prove a hardship in that many times players are logged off involuntarily due to communications failure, local computer failure, or the like. Accordingly, it is preferred according to the invention that a player that logs off, either voluntarily or involuntarily, be permitted a time window in which to rejoin in the limited access area, for example 10, 20 or 30 minutes. The system records when the player last left the game and compares it to the time of return. If within the 30 minute limit, the player reappears in the limited access area at the same location that the log off occurred, if the logoff was not intentional.

Other limited access area possibilities include providing a number of entrances to the zone at different locations, only one of which is open at any given time provided that the players have no way to know which entrance will be currently active without finding out for themselves. In the alternative, the zone is programmed to open only to characters on a related quest (e.g., AC2 appears to require a quest to enter its vaults), no one else can enter. Players cannot re-do the zone once the quest is completed, and are limited to a certain number of tries, then the quest is failed and the character cannot re-enter the limited access zone.

In a PvP situation, players may be competing to complete the quest first, and only one can get credit for it. One group may be assigned the opposite of the first group's quest, namely to stop the first group. Both groups may enter at a holding area and cannot proceed further until the opposing group is also present and ready in its respective holding area to enter and begin the quest. For example, assuming each group enters from a separate location, a graphical gate bars each group's way to proceeding further into the area until all groups are in position and have been so for a certain minimum period of time, such as one minute, or all groups indicate that they are ready. This can be termed a PvP competitive quest, where players in rival groups are allowed to attack players in the other group, if such would further their aims. In more complex variants, players are not informed of the nature of the other group's quest. It may be competitive, or may be something entirely different, rendering conflict unnecessary. The computer controlled opposition may be too hard for either group to overcome alone, so that cooperation is eventually required if either group is to succeed. The player groups upon entering have no idea which of these situations they are in and must find out as they go.

MMORPG terrain features are presently rendered using 3D graphics software engines. These engines re-render terrain features as the character moves to simulate what a human observer would see walking along in the game world. As such the terrain features change as the character moves, but the perspective remains substantially the same unless the player changes it. According to another feature of the invention, a hidden terrain feature is provided which is only visible at close range (the character must be a certain distance or less away before the hidden feature is rendered on the player's screen.) In a more elaborate version of this feature, the player upon passing within the minimum distance makes a check against a character attribute and only sees the hidden feature if the attribute (e.g., perception) check is made successfully. For example, upon nearing the side of a hill, there is a hidden cave entrance which dwarf Borlin may see. He has a 25% perception attribute that gives him a 25% chance of seeing the hidden object. The game software makes the check and if successful, renders the hidden feature on the player controlling Borlin's screen. This type of check may limited in the number of attempts (such as one per hour per hidden feature). The attempt may be triggered automatically by passing within the minimum range, or may only occur when triggered by a player command. It may also be permitted to allow the entire group to see the hidden feature once one member sees it and points it out. For simplicity it may be that the hidden feature can still be accessed even by players who cannot see it. For example, the keen eyed elf sees that the wall ahead is actually an illusion, but even the barbarian can pass through it. The game designer selects the desired combination of characteristics for the hidden terrain feature.

By combining the above features, a game could have an area which is truly difficult to enter because its entrance moves, is hidden, and requires fulfilling an entry condition to enter. According to a further aspect of the invention, the rewards that can be found in such an area are scaled based on the difficulty, not only of the creatures to be found there, but on the ease or difficulty of finding the area. Indeed, the entire challenge may be finding a secret chamber and getting into it, avoiding any traps. There may be no creature guardian, and as such even a low level character is capable of earning a fabulous treasure with sufficient skill and luck. As such, character experience may be awarded merely for gaining entry to the limited access area, and more for reaching its innermost chamber wherein the special treasure is located.

DAOC has a strong system of guilds, wherein guild membership is recorded as part of a player character's data. A guild may be allowed its own limited access area, such as a guild house or even a series of dungeons connected thereto which only guild members can get into. For example, Lothar who is not a member of a guild wishes to join the Order of Light. As in DAOC, a current guild member or officer makes Lothar a recruit by issuing an invite command, followed by an accept command from the player controlling Lothar. To move from recruit (level 0) to member (level 1), Lothar must successfully negotiate a haunted maze that is adjacent to a guild hall of the Order. This maze is a limited access area that only guild members at level 0 can enter. Optionally, once they complete their mission within, they are promoted to level 1 and can no longer enter the limit access area. In no event would a non-guild member be able to enter the maze. It should be noted that a guild for purposes of the invention is a permanent (until broken) association of players that carries over from one game session to the next, whereas a grouping or party is a temporary association between players characters that generally ends by default when the player logs off (disconnects from the game server.)

Some games such as Asheron's Call permit, on a basic level, players to make semi-permanent changes to the game world. For example, a player who buys a house may decorate the walls with items and thereby furnish the house by assigning items to positions on the walls marked by item spots. According to the invention, a guild may design training areas for its members by assigning creature spawns, traps or puzzles from a menu or list to locations within its limited access area, allowing players limited customization or area design rights within limited area of the game world. This could be done in a manner similar to DAOC's current housing system, whereby the guildmaster buys or selects creatures and objects from an NPC, puts them in inventory, moves to the desired location and then drops them. The creature or object then appears and acts accordingly. The use of the items is restricted to allowed areas only.

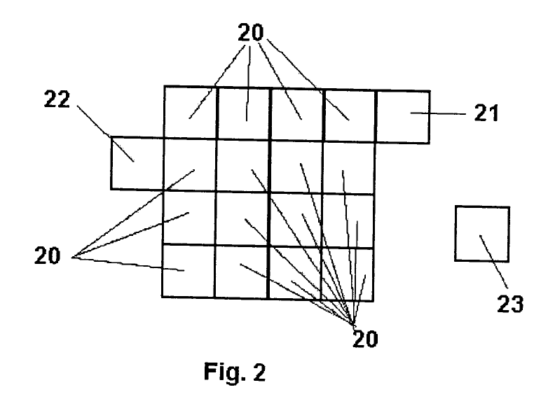

Such a customization option may also be allowed to players who have subscribed to design and run a player designed zone. The player zone may permit the use of original, non-randomly generated game content supplied by the player, within the limits established by the game provider. As such the player acts as a sort of “game master” within the player designed zone, an option missing from currently available MMORPG's. See, for example, FIG. 2, where a matrix of common zones 20 operated by the game provider adjoins a number of outlying zones 21-23 where a controlling player designates creature and encounter spawns and may also act as an NPC (the local lord, wizard, or the like.) Zones 21, 22 can be entered directly from an adjoining zone 20. Zone 23 can only be entered by “magic” transport, e.g. a game effect which teleports a character into the zone. According to a further aspect of the invention, this option is made available only to players that have reached a high level of achievement in the game, such as attaining difficult goals or very high character or skill levels. Such a character then semi-retires to take on the role of NPC, and may after a time abdicate that role. Indeed a player designed zone may revert to a default model or vanish if the controlling player takes no action to update it within a certain period of time (e.g., a month).

While improvements to special areas such as dungeons would be welcome in MMORPG's, the invention further seeks to improve the common areas used in the game as well. According to the invention, two or more several different types of spawn generation algorithms are used. A Type 1 spawn as referred to herein is essentially like a steady state universe. Creatures are respawned from certain predetermined locations (spawn points) whenever the number of creatures in that area becomes depleted as players kill them to gain experience. Certain unique creatures may spawn only under certain conditions (e.g., at night, or at fixed times of day.) Objects a.k.a. loot appear only when a spawned creature dies. This is the DAOC model. In a Type 2 spawn, creatures and objects (such as treasures or traps) are set at start and do not re-appear during the game. An area which has been throughly explored by players becomes empty. This is not considered a good model for an MMORPG zone, since the game runs continuously and there are no convenient times or ways to reset an area, other than by closing down the server for a while.

A Type 2 spawn is useful for limited access or non-persistent areas according to the invention. For example, the City of Mist forms from clouds and moonlight, and vanishes when the sun rises, to re-appear the next night. Games such as DAOC maintain a faster than real time day-night cycle. For example, day and night are each one hour long in real player time. This could be used as a convenient way to reset an area, since players are only permitted a limited time (one hour) in which to make their explorations before the area disappears again. Players failing to leave the area before it disappears may die (in game terms) or simply be transported to their bind points or to the entrance area without penalty.

A Type 1A spawn according to the invention is similar to Type 1, except that the spawn locations may change either drastically, gradually or both. In a drastic change system, a spawn point may be permitted to expire (no more creatures appear there) and is relocated elsewhere on the map, either near or far away, preferably according to certain criteria. For example, the grass nomad spawn can only relocate to another spot with grassy terrain, and could not appear in water or woods. In a gradual change system, the spawn location drifts either randomly or according to a pattern. The change is incremental each time, e.g., every hour the grass nomad spawn position shifts a short distance either randomly or according to an algorithm. For example, the spawn is assigned a direction such as north and continues to move that way by 1 unit of distance per increment of time until a change is indicated, such as by passage of time (a game day goes by) or the spawn reaches a terrain it cannot enter. This would simulate the grass nomads moving north until they reach the edge of the forest, then moving off in a different direction.

In a Type 3 spawn according to the invention, spawns occur of encounter areas instead of or in addition to Type 1 and 1A creature spawns. An “encounter area” for purposes of the invention is a one time spawn of creature(s), object(s) or other game elements does not reset or repopulate once players have finished it. An encounter area may move or be static. However, unlike D2 where the map is filled with such encounter areas at start, Type 3 encounter areas appear at other locations as existing Type 3 encounter areas are finished by players, so that a more or less steady supply of encounter areas are on the map at any given time. Preferably these re-spawns occur at places that are clear of players, i.e., no player character is within a certain distance of where the spawn occurs. For this purpose it may be necessary to limit the number of subscribers to a given game server to a maximum number, rather than allow the map to become overcrowded. In the alternative, the respawn could simply be delayed if players are all over the map, until a clear spot opens.

A more interesting game experience is provided if these various spawn types (1, 1A, 2, 3) are all used together. The game context will often be the best guide as to whether a spawn should be fixed, drifting (gradual movement), randomly moving or one time encounter area. Thus, the goblin village has a map anchor (a series of huts, campfire, etc.) and is best left a fixed spawn, along with the giant ants on their ant hill. The wild oxen are a shifting spawn, limited to the grasslands, as befits the nature of the creature. The mole people are a drastically shifting spawn. The spawn center is a graphic of a hole in the earth, which disappears when the spawn moves and reappears elsewhere. The moor banshees are also a drastically shifting spawn with no graphic anchor. Since they appear only at night, the spawn location change occurs at sunset of each day-night cycle and is limited to certain predetermined terrain or region (as defined by map coordinates.)

Games such as DAOC and EQ suffer from a lack of variety in things/items that can be discovered in an indoor or outdoor area. Ostensibly this is because the MMORPG format requires a steady-state world where a quest once accomplished shortly thereafter resets (“re-spawns”) for the next player to come along wanting to do it. A puzzle or trap that is permanent and the same every time is of little use in such a game because players publish their findings on the Internet, and almost everyone would then know in advance where the trap or puzzle is and how to solve it.

According to one aspect of the invention, this problem is avoided in part by use of a software algorithm that generates a new puzzle each time the feature spawns, or for each player that attempts it. In a most basic form, this is done by randomization of a starting database of puzzle elements. The puzzle generator can, for example, generate several thousand or million different combinations using random number generator algorithms, and thus the likelihood of repeating the same combination twice in a row in remote. As a simple example, a vault can only be opened by unscrambling a word and entering it correctly. The word is preferably game related, such as the name of a creature that appears in the game, with the letters scrambled (biglon=goblin). The puzzle may not even say directly that the answer is obtained by unscrambling. The player upon clicking on runes written on the door gets the message “Say biglon and enter,” for example, but the character says “biglon” and nothing happens. This is a simple example and, of course, it may be desirable to use more sophisticated puzzle elements would be used in an actual system.

According to another aspect of the invention, spawning occurs for objects or other non-creature elements. These may be termed object encounters in the sense that they relate to inanimate objects drawn as part of the game world which normally would have no effect other than blocking movement. A simple example is presented here for a dungeon feature. The system first selects the feature type using a random number selection: 1—door, 2—wooden chest, 3—crate, 4—vase, 5—coffin, 6—statue. Each option has a further sub-list of features associated therewith; the door list might for example be: 1—triggers strange sound, no other effect; 2—is trapped, one opening takes damage if nearby; 3—is locked, requires key item to open. These are comparable to the simple items to be found in the world of Diablo2 which were generated in a randomized manner, but did not “spawn”. Instead, in Diablo2 and other non-MMORPG's, the object is initialized at the start of the game, remains until the entire game ends or is reset, and disappears when triggered by a player. Object spawns in a MMORPG would be randomized over a wider area, e.g., an entire dungeon level. It is preferred that such spawns not occur where players are standing or even within sight of a player.

A more advanced form of one-time spawn of the invention can be generated using a logic-tree based encounter area generator. These encounter areas are almost never the same twice. The software for creating the area consults a series of tables and chooses entries using a random number generator. The first or root table indicates what is present in the area from a list. The additional tables further characterize each item that is on the list. Very simple example: on first table, roll of 1=trap, roll of 2=treasure, 3=both, 4=creature(s), etc. Some of the items may be assigned links. If the trap and treasure are linked, the trap does not go off until the treasure is disturbed. If unlinked, the trap is triggered by proximity. A further table specifies the nature of the trap, the nature of the treasure, etc. The more elaborate the tree of tables, the more interesting and less predictable the encounters become. As the tree of tables becomes more elaborate, the end result might be, for example, a campfire (temporary terrain feature), a pair of orcs near the fire, a hostage captured by the orcs who is grateful upon release (experience bonus), a pit trap the orcs have set near the fire, and a group of further orc archers roving nearby who will come when one of the orcs raises the alarm. Once the hostage has been freed, the encounter area disappears and a new one is generated by the system somewhere else.

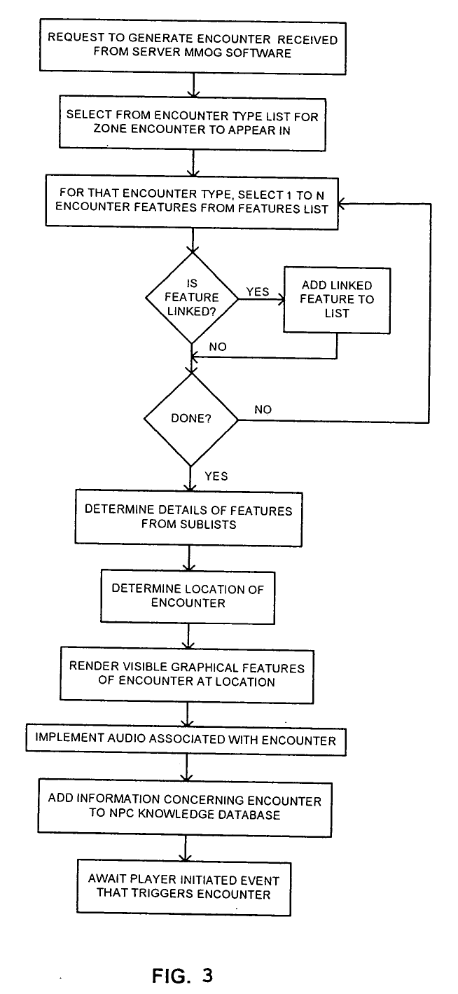

FIG. 3 illustrates basic program logic the encounter generator follows in the process of generating an encounter. A game event from the game server software triggers a request for a new area to be generated. This could be, for example, each game day at a certain time, and may result in the disappearance of an encounter area then in existence. The generator first consults a table or database of base encounter types and selects one using a random number generator. Data for each base encounter record in the database will include creatures and object types included in the encounter as well as the number of each or a range for the number of each, the exact number determined at random within the range. The encounter record preferably also includes a terrain type data element, which is the type of terrain the encounter must be spawned on, as well as a special effect for the encounter.

A simple example is a bandit ambush. The location of the ambush is chosen according to the terrain type, which in this case is a road. Accordingly, the encounter is centered on a road square somewhere in one or more realm zones. This can be selected using a software loop that selects map locations at random until one with the right terrain in it is selected. Once the location of the encounter is determined, the encounter record requires 4-8 bandits, 0-2 wolves or dogs, 0-1 decoys, 0-1 traps and one bandit leader. These can be selected from the a master creature table for the game, and may be of a level appropriate for the zone in which the encounter is to happen. If the selected location is a zone populated primarily by low level creatures, the bandits are preferably of similar level to others in the zone. Since the encounter type is ambush, the enemies do not appear until the encounter is triggered (i.e. they spawn when a player approaches the target location on the road) or they may be disguised as bushes until the encounter occurs. If a decoy is present, a table of possible decoy types is consulted. It could be, for example, an NPC who appears to be a wandering master or merchant standing in the road. The encounter is then triggered when players try to talk to the decoy NPC, or attack the decoy. If a trap is indicated, then a table of traps is consulted. Trap types could include snares, explosions, or the like, centered on the encounter location. Thus if a snare is selected, the player crossing along the road is temporarily immobilized as the attackers appear.

Once the encounter has been triggered, a timer is started for generating a new encounter at another random location. When the timer expires, any creatures or objects left over from the old encounter disappear. The new encounter might be the same or different as the previous one. For example, the new encounter selected is a special NPC merchant. The terrain type is town. The merchant sells wares selected from a list of possible types not sold my normal merchants always present in the game. For example, a merchant is selected that sells magic weapons of various types. From a list of doodads, a decorated wagon is selected and appears near where the merchant is standing. The merchant will sell to anyone who happens by, but disappears when a certain number of sales have been made, or when a timer expires.

Special effect sites may be provided either as fixed terrain features or one time spawns. These are locations that confer a special benefit on the visitor, if of the appropriate type and usually in return for something. A player may make an offering at the Temple of Fire and receive a flaming weapon enchantment with a fixed duration, or in the case of a mage, a bonus to fire damage spells. Another variant is the “place of power”. In certain areas, the powers of magic may be diminished; in others, creatures of evil are strengthened with those of good weakened, etc. These can be implemented in a manner similar to realm bonuses for relics now used in DAOC. When on holy ground, for example, evil characters take intermittent damage and/or good characters have their abilities enhanced. In some such locations, certain spells or powers may fail to function, e.g., evil magic doesn't work or works at only 50% effectiveness near the Temple of Light.

A similar effect can apply to the heavens. At various times, certain events in the stars will temporarily swing the balance of power. A blood moon, for example, may give all evil creatures a damage bonus for its duration. The astrology skill can be used to predict these patterns in the short term, but never with total accuracy.

Currently computer-controlled NPC's used in present MMORPG's are robotic in their responses. A further aim of the present invention is to improve the quality of player-NPC interaction. A company sponsoring the game may be reluctant to pay an employee to act out the NPC's role in the game world by running a “live” NPC. A hybrid solution to this problem is to hire players, ones that have proven their skill and experience with the game with a certain minimum number of hours played and/or levels attained, to run an NPC or even to convert a player character of high achievement into an NPC. The player-controlled NPC may be required to be online a certain number of hours per week in order to maintain player controlled NPC status. During periods when the player is absent, the NPC reverts back to robotic responses to actions in the game world as is done presently, but such responses may be programmed by the controlling player so that others may interact with the NPC when the controlling player is not logged on. An engine permitting conditional replies would be most preferred. For example, the NPC has agreed to tell the location of a certain place to any player that gives a certain item to the NPC. The controlling player, interacting with the system, designates the item and enters the text response. Thereafter, when players offer the item to the NPC, it is accepted and the NPC replies with the desired information. The person who set up the response need not be online when this happens.

When controlled by a human player, the NPC's conduct will be guided by a “script” or guidelines of actions the NPC should take in response to player actions. The guidelines will be subjective and leave room for the player's imagination in determining what the NPC will do. The NPC will usually have one or both of a boon and a penalty. Players that come to the NPC and do the right thing (according to the script) will receive the boon, whereas players that annoy the NPC may suffer the penalty. A boon may be a temporary or permanent stat or skill increase, a monetary reward, a magic item, an important game world clue, or the like. A penalty could be, for example, being banished from the NPC's presence (as by being teleported away a random distance.)

Player NPC's can be operated in an offline response mode, and this may be especially suitable if the NPC is operated by a game company employee which may vary. The NPC software operates the NPC robotically, but a player is permitted to put a question to the NPC requiring human player intervention and then return to find the answer. For example, the NPC is a sage in a library. Player characters may come and, for a fee, ask the sage to research a game topic using a game command naming the topic, or may ask a specific question. The NPC takes up research questions in order of arrival (or in order of the amount of gold or other game money paid) and an answer is prepared offline by the one controlling the NPC. When the character returns and talks to the NPC again in the game, if the research is not yet done, the NPC says so. If it is done, the player gets a text message (or graphic or both) describing the outcome of the research. This is but one example. Robotic NPC's can be programmed with a similar response pattern. For example, a fisherman may take “orders” for exotic fish needed as components for spells or magical research. The player states what he or she is looking for and the NPC goes to see for a while, perhaps returning with the desired item or not, which he then gives the player later in return for a payment.

In other, non-MMORPG computer games, NPC replies have been somewhat more elaborate, offering for example multiple choice actions to the player, or making conditional responses triggered by key words or phrases in the player's text question. The present invention takes the latter approach a step further by providing an artificial intelligence chat system for NPC's in MMORPG's and other computer games.

According to the invention, a database of facts that may be of interest to players is compiled, classified into tables by how easy/hard the fact is to learn (e.g., common, uncommon, rare) and a key word or words associated with that fact. The database is preferably different for each NPC area (town, for example.) There will similarly be a database of rumors which are false, and databases of unhelpful and hostile responses. Each NPC is classified by an attitude (friendly, neutral, hostile) and by what level of knowledge that NPC possesses. Players are permitted to put text questions to the NPC. In this system, the player might ask “What do you know of the red robed one?” The query is parsed to determine how many key words or phrases are in the query. Non-key words are ignored. In this case, the answer will then be selected at random from among possible facts about the red robed one as key phrase, but only an NPC with access to rare information will be able to provide really useful information to the player, and the NPC must be friendly in attitude towards the player. Attitude may depend on alignment of the character as compared to the NPC (as further described below; a good NPC won't talk to an evil character), on specific actions such as doing a service for the NPC, or offering a payment to the NPC. The system adds an element of interrogation of NPC's and solving problems by information gathering. Language skills may also play a part in NPC interaction. For example, in a dwarven village some of the NPC's there do not speak the common speech and can only be questioned by someone who knows the language of the dwarves.

The database(s) of information and rumors remains mostly the same over time, but may change gradually in response to one time world events. For this purpose, each new world event should have associated information that is added to the NPC knowledge base for as long as the event is in progress and then removed. For example, added to the “common” list in a town which is nearest the sudden appearance of a vampire is “There have been many strange disappearances here by night”. A more valuable hint about the same event: “Someone has broken into the ruined mausoleum west of town.” These messages are removed from the database once the menace passes. While some game information will be available from only one special NPC, this is to be the exception and not the rule, to make the game less predictable.

An NPC database used in connection with the fact databases or tables is consulted to determine whether the NPC tells the player a common, uncommon or rare fact. In a simple form, Bolo the Village Idiot has entries of 100, 0, 0, indicating that no matter what he is asked about, he will only tell player commonly know facts (100% chance of common fact, 0% uncommon, 0% rare.) Cain the Sage, on the other hand, might have entries of 50, 25, 25. A player might have to pose the question several times in order to hear the rare response, but care should be taken to avoid putting players through undue repetition.

Ideally the persistent part of the game world is not static. One time special events occur that affect all players or all players in a given area. In simplest form, these can be randomly generated one time creature spawns. The creature may wander randomly or may follow a pattern such as moving from town to town, then off the map (ending the creature's appearance). The creature may be a group of creatures that move together. In DAOC for example, this could be expressed as a king's retinue that patrols the frontier keeps and then returns to Camelot. The king NPC is a form of moving keep lord and special awards may be obtained from him as he rests at each keep, or for fighting in his service (realm point bonus percent, per DAOC's realm point system.)

In a more complex form, consider the “creeping blight” example. In the haunted forest there is an abandoned house. At some point a high level witch and hench-creatures appear there to take up residence. The witch casts a spell using her cauldron that starts expanding the haunted forest area, gradually taking over more and more terrain. As this sphere of influence grows larger, more and more evil creatures are spawned in the new haunted terrain. The realm has to take action or the snowballing of evil will continue unchecked. Once the witch is slain and her cauldron destroyed, the haunted forest returns to its former size. A very special reward such a large number of experience points and/or a great magic item goes to the ones that defeat the witch, and the reward escalates as the crisis grows greater (experience reward is proportionate to the number of squares converted.) Another example is the wandering monk who is actually a grand master of martial arts. Approach him properly and learn a new and unique skill not learnable in any other way. He follows a path over the land that may take him a week of real time to traverse, then he is gone, perhaps to reappear in the future.

Player NPC's can participate in these one time events. Each player NPC may be given a weekly report of upcoming game events that would be known to that NPC (based on NPC's location, position in the realm hierarchy, or the like.) No one player-recruited NPC should have access to all games events and the information may on occasion include inaccuracies that can be used to detect dishonest NPC's who leak information to their friends. A player NPC may receive a real world reward for participating, such as a free game subscription.

Player characters need not disappear from the game world when the player is offline. A player can hire himself out to a local keep lord, for example, in which case the character would act according to guard or archer NPC AI for that keep, and aid in its defense if attacked. There would be risk of being killed in doing this. It should also be possible to program a character to hang around a location, such as the guild hall, and take triggered actions in the player's absence. For example, if Acton clicks on Logar, Logar is programmed to give him an item he ordered and a message written earlier by the player appears. The offline player can also program global actions such as buy or sell a certain item to anyone who comes along, and have an inventory of things for sale, similar to NPC merchants.

Creatures or “MOB's” in MMORPG's generally have no effect on their environment. According to a further aspect of the invention, mobs may have associated signs that indicate they are near, which signs are reflected either as game sounds or graphics or both. For example, a creature may leave tracks evident as small changes to the foreground texture. The tracks gradually fade and disappear, preventing the world from being written over with them and allowing players to note whether the tracks or fresh or not. Similarly, a large dragon at the bottom of a series of caves makes a snoring sound when it is not active. As one gets closer to the dragon, the sound grows louder. This is in contrast to current sound effects which do not vary in volume and for which triggered sound effects are very rudimentary. Some sound effects should have game-related meanings, whereas others represent ambient background.

For large or very special creatures, the signs may take the form of a trail or scorch marks or destruction. Some of these signs may require special skills to see, e.g., the trail marks appear on the screen of a ranger, but not for other classes, and the probability of seeing the tracks varies with the ranger's skill level in pathfinding, improving with level. Signs may also take the form of “doodads” or special graphics overlaid onto the basic 3D map. The headhunters, a relocating spawn, when they move their camp within the jungle zone, for example, post a perimeter of spears with skulls on top around their camp site to warn away intruders.

Current MMORPG's borrow the concepts of experience and leveling directly from tabletop FRP games more than 25 years old, almost unaltered. In both DAOC and EQ characters are ranked by levels wherein level 1 represents the lowest level, weakest character and level 50, 65 or similar upper limit represents the highest level character in the game. Level affects many character statistics, such as life or hit points, the ability to attack and defend, resistance to enemy attacks, and available spells. Level is a convenient system for the designer, but creates characters that tend to have lockstep characteristics, even given some ability to choose specialization by spending training points at each new level to learn new skills (per DAOC).

Experience is a more severe problem. Typically, over 95% of player experience to a maximum level must be earned by killing of creatures or by performing quests which amount mainly to traveling from place to place and killing designated creatures. The majority of a player's time is spent fighting, often fighting the same creatures over and over again for hours in so-called camps, where a group remains at a spot where suitable enemies are known to spawn.

There are various ways experience can be handled other than points for killing creatures or performing mundane tasks. The existing system rewards players that spend an inordinate amount of time online and penalizes players who don't have time to play games 6 to 10 hours a day. Assuming for the moment that a system akin to levels in retained, one experience point system according to the invention shifts the emphasis away from repetition and towards accomplishment of a variety of feats. An experience award system according to the invention awards experience on the basis of the following which may be likened in some cases to tasks or quests:

| | |
|---|---|
| (1) Without any outside aid, defeat a creature of higher level | 5% |
| (2) Defeat ten different creatures of a level equal to or one less | 10% |
| than the character's level | |
| (3) Perform an epic task (see below) | 15% |
| (4) Perform a quest of keyed difficulty | 20% |

These are bonuses based on the total amount of experience needed to reach the next level. Each bonus can only be earned prior to leveling. The first is a once per level bonus for defeating an enemy at least one level higher than the player character. The second bonus rewards the player for seeking out a variety of enemies, rather than just camping at the same spot fighting the same creature over and over again. The third is essentially a problem solving exercise for which an engine may be designed to generate an infinite variety of such problems, as described further below, as compared to DAOC tasks which involve bringing an item from one town to the next or killing a specified creature type within a time limit.

The fourth is preferably a quest to find and retrieve something from a special area such as a dungeon. The special area is preferably a subsession as referred to above that exists only for the player and possibly his group mates, but not for others. For this purpose, the hidden entrance graphics may be used. For example, the player is told to seek an abandoned barrow and given certain general directions on how to get there. The barrow location in the common area of the game map is saved for that player. It appears on the map only when the player assigned the quest comes close enough to see it, and does not exist prior to that. Even then it is preferably visible only to that player and his or her group members, not to others who might be in the area at the time. The floor plan for the special area is either selected from one of a number of existing plans, or generated at random or by randomly combining a series of geomorphic sections. The item or thing the player is seeking is placed, generally at a location remote from the entrance location, and a number of encounters of suitable difficulty for the player are placed throughout the areas, other than at the entrance. If the player brings friends along, creature opposition can be scaled according to the party size upon entering (e.g. instead of two orc sentries, there may be two per group member.)

It is also possible for groups of characters to seek a common quest, if all members are within a certain number of levels of one another, for example 8 to 12 or 9 to 11. The quest is assigned to all members individually as well as together, so that a party member forced to leave early can return later and solo the quest if necessary. If all party members do the quest together, all receive the experience award when they return with the sought item. If the quest is aborted before completion because the player(s) died, the area may reset (be either the same or different) upon the player's return, or the quest may be declared failed and the bonus is unavailable for that level.

The epic task is preferably generated by a software engine capable of randomly generating such tasks using the map and game parameters, so players can never know the solution in advance or post it to the Internet. According to one such generator, an NPC location is selected at random, such as a town or castle. The location of the person or object sought is determined, and a series of locational clues are generated using an algorithm. All of the clues taken together will give the desired location unambiguously, and it is possible to find it with less than all of the clues through process of elimination or shrewd guesswork. Clues example:

NPC1: What you seek is near a stand of willow trees.

NPC2: What you seek is near a large boulder.

NPC3: What you seek is north of a goblin hunter camp.

NPC4: What you seek is south of a black obelisk.

NPC5: What you seek is east of the Town of Vawn.

NPC6: What you seek is west of Tor Castle.

NPC7: What you seek lies northeast of here.

NPC8: What you seek lies east of the Tower of the Morning.

Four of the clues define a bounded area of the zone map in which the target lies, once identified. A fifth and sixth identify terrain landmarks near the target. A seventh gives a general line of march from where the character is now to where the goal is. The eighth (NPC8) is a directional clue inconsistent with the other four. It is up to the player to work through and eliminate the false clue. The clues are learned from talking to certain NPC's, by searching is designated areas, or the like.

This is but one example of a system that generates quests or puzzles for players that have some difficulty, yet can be generated by the game software rather than written by human authors. The latter is essential since it is not practical to provide more than a certain amount of original human-authored game content to such a game. Scavenger hunt quests are also amenable to random generation, as where the player is sent to gather items on a list which are found in certain places or dropped by specific creatures upon death.

Player combat experience can also be adjusted based on circumstances. In one form, players receive a lot more experience for a battle in which players took a lot of damage (almost died) but still prevailed against strong opposition. The remaining life of the player or group at end of battle becomes an experience bonus factor. An individual player also receives a bonus for certain defined acts of heroism (taking the most damage, doing the most damage to the enemy, or saving a friend close to death, etc.) A heroism algorithm considers multiple factors and makes an exp award decision after a fight is over.

According to another aspect of the invention, experience in the sense of points earned in order to progress is not used. DAOC has a trade skill system in which repetition of the skill with items of ever increasing difficultly leads to small incremental increases in skill level, with each skill level tracked separately. In preference to a level based system, a system of improvement through successful use is extended to all skills. Each skill starts with a certain relatively low chance for success, such as 25%. In the case of a weapon skill such as swords or blades, each successful use resulting in a hit on an opponent has a certain chance to provide an incremental improvement, e.g. +1%, improvement up to a certain level. The chance for improvement is greater with a more skilled or powerful opponent, less or non-existent for an inferior opponent. Similarly, where the skill level is expressed from 1 to 100, it can also represent a percentage chance of success. In the case of a weapon attack, a success may not actually result in damage to an opponent since the attack may be parried, blocked or evaded as a result of defensive skills of the defender. The damage done as the result of such a hit will also vary depending on the armor the defender is wearing, and may even be reduced to 0 as a result. Improvement in a skill under this system occurs up to a certain limit and then ceases until the player has taken the necessary steps to proceed further. As the player reaches 50% in the use of blades, for example, a specific quest must be undertaken and completed before further improvement above 50% is possible. The quest may be as simple as finding a new master to teach the player.

Once a skill has reached a predetermined level signifying mastery, such as 75%, the player is permitted to learn one or more advanced forms of attack of the same type. In a sense, mastery of the basic skill acts as a prerequisite for the advanced skill. D2 has a skill tree system in which basic skills in the series must be learned to at least level one in order to take more advanced skills in the tree. The present invention requires mastery in order to move to the next skill in a tree, namely learning the skill at an introductory level and using it repeatedly in order to increase it to a mastery level before the next skill can be learned, again at the introductory (lower) level. The process may be repeated so that a third, still higher skill in the series can be learned. Each higher level skill may have a special requirement before it can be used, such as seeking out a master able to teach it to the player, or acquiring necessary information or ingredients as described hereafter.

Advanced fighting skills higher on the tree are learned from masters. These are similar to trainers, but each teaches only one school or technique and may be other players (per apprenticeship above). A character can only have one master, so committing to a school means not learning what the other masters have to offer.

Ultimate fighting skills are at the top of the skill tree. These are learnable only from special wandering NPC masters who must be located, or from rare tomes found as treasures in dungeons. The school of the ultimate skill must match whatever school the player belongs to. These skills are not limited to attack styles, and could include special abilities such as:

a. Charge up attacks. Click button to start, then again to finish charging and deliver the attack. During the time in between, more power and endurance go into the attack, and its power and damage increase accordingly.

b. Continuous styles—similar to charge up, but lasts as long as maintained. During that time its special ability is in effect (player gets massive parry bonus, player deflects missiles and spells, etc.)

c. Final strike type attacks—style destroys the weapon used to deliver it, and weapon must be of a certain high quality and type to use the final strike.

d. Countereffect—attack of an enemy is redirected back against him. The player character must practice the attack by using it on enemies or in “friendly” duels in order to increase the chance of success. The sum total of the player character becomes a patchwork of skills at varying levels, and there is no character “level” per se.

Musical character types such as bards or minstrels cannot, in DAOC, play songs other that a few canned sound effects. According to the invention, a user programmable music system is provided for such character types. The game comes with canned tones similar to MIDI sounds or WAV tones, permitting player to program own tunes by entering a musical script and saving it as a macro. Since only a short text string passes through the Internet, there is no problem posed by generating the tune at other end user PC's. Most MMORPG's motivate players of similar level to group together and make it difficult for high and low level characters to work together beneficially. According to the invention, as a condition of advancing past a certain level, a character must serve an apprenticeship to another player. There may be a few NPC's who can be used for this also. The apprenticeship mainly involves grouping with that player for a fixed period of playing time. The high level player benefits from having an apprentice because the apprentice does not share in experience or reduce it in any way for the master, but can provide benefits (albeit low level). In DAOC, this would be comparable to a level 10 minstrel grouping with a level 40 wizard. After the apprenticeship is over, the player learns new skills. In a more advanced game where players are permitted to create their own spells and melee styles, the apprentice learns one special spell or style created by the master. A player master can have only one apprentice at a time.

Spell research may be conducted by players at a special location, such as at a magical library. The player must have sufficient skill and/or level to create the spell. The research may require quest-like gathering of ingredients or knowledge (lost runes of power or such.) In one embodiment, the creator first runs through a spell “questionnaire” which defines all of the relevant parameters, such as damage, effect, range, etc. The level of the spell and power needed to cast is then computed from what the player selected. The player names the spell, and is then given a quest like series of steps needed in order to complete the spell. Upon completion, the spell becomes permanently available to the character and may be taught to an apprentice. As an alternative to allowing such custom spells, certain predesigned rare spells can only be learned by completing a research process similar to quest steps. These spells are kept secret from the gaming public and new ones may be added on an ongoing basis, so that the Internet spell guide is never complete.

Guilds in DAOC are little more than loose player clubs or associations. Guilds of the invention may be special orders dedicated through system game effects to specific purposes. For example, the guild may have “templar” status. As long as a certain temple or castle the guild is dedicated to defending remains intact, all guild members receive a global stat bonus and/or an extra bonus when fighting in that area. The entire guild suffers a penalty if the place they are sworn to defend is taken. A guild may have an exit stigma or curse. This is designated by the guildmaster at creation. Any character leaving the guild voluntarily or by being kicked out may be cursed, or marked with a black symbol that can be seen on the character and long lasting and/or difficult to remove.

Special purpose guilds may be headed as guildmaster (GM) by a computerized NPC rather than a player. Members must be of specific alignment/class and perform a quest in order to join. Quests of progressively greater difficulty control rank within the group. At different ranks within the organization, different powers are conferred. The GM will at times call upon one or more group members to perform a mission and players that ignore the summons will be demoted or removed from the group. The GM at other times will assign the entire guild a mission, and if it is not accomplished within the time set, all suffer.

For example, to all members of the Order of the Silver Tree, a message is broadcast (and appears whenever a templar character logs on) that the High Templar orders all members to besiege and capture a certain castle, and gives the time remaining. Players who participate gain points towards ranks within the organization, which in turn confer special abilities. A templar reaching the rank of Captain after gaining a certain number of points performing such missions gains an ability which could be comparable to a DAOC realm ability, but is preferably a special purpose leadership ability that applies only members of that organization. For example, all templars grouped together receive a bonus based on the highest ranking templar in the group:

| | Melee | Melee |
|---|---|---|
| Rank: | Damage bonus: | Defense Bonus: |
| Guardian | 0% | 0% |
| Corporal | 1% | 1% |
| Sergeant | 2% | 2% |
| Lieutenant | 3% | 3% |
| Captain | 4% | 4% |
| Commander | 5% | 5% |

Magical organizations may have a place of power where their abilities are heightened. This type of guild is especially suitable for players who have little experience role playing or working together toward a common cause.

Emotes are simple animations that a player can trigger cause his character to dance, clap, cheer or the like. They are one of the few ways players can effectively role play, given that current game offerings do not allow real time voice communication between players. According to the invention, two or more person emote animations are provided. For A to dance with B, A invites B to dance, B must accept, then a double animation is shown if the two are standing close enough together. A group animation, such as a circle dance, is possible where all members of a group agree to do the dance.

The following aspects of the invention concern player vs. player aspects of the invention. In a preferred form of the invention, the game system shapes the manner and circumstances under which players battle one another, and the reasons why. DAOC has established open PvP servers on which, with a few exceptions, any player may attack any other player at any time, with or without reason or provocation. For the most part, actions which might be considered immoral or unethical have no long term consequences beyond those created by the players themselves. For example, if members of the Slayers guild are constantly attacking members of other guilds, the guild becomes known for its practice of attacking on sight, and is placed on the enemies lists of other guilds. An enemies list is maintained by the server for each guild. When a player of a guild “cons” (mouse clicks on) a player of an enemy guild, a system message tells the player that the other player is a member of an enemy guild.

According to the invention, the game system itself takes part in fashioning consequences for player behavior. Alignment in its simplest form may be tracked as a player statistic as good, evil or neutral. One of these three alignments is selected when the character is created. The alignment preferably corresponds to a single numerical alignment statistic or score. For example, an alignment of 100 or more is considered good, an alignment of 0 or less is considered evil, and an alignment in the range from 1 to 99 is neutral. The starting alignment score, which might be 120 in the case of the paladin discussed further below, moves up or down depending on the players actions. In a simple embodiment, a good or neutral character killing a creature or player character with an evil alignment is considered a good act, and increases the sliding alignment score. Conversely, killing a creature or player character with a good alignment is considered an evil act, decreasing the sliding alignment score. Killing a neutral creature or character is mildly evil, resulting in a smaller decrease in alignment score.

Certain circumstances may modify the results. For example, killing a being considered “holy” (alignment 500 or more) may result in a much larger shift towards evil. For this purpose the alignment change of the attacker may be based on a percentage (e.g., 10%) of the target's alignment score. Killing the holy hermit with an alignment of 500 thus results in loss of 50 alignment points to the killer. The death of the target is preferably not the only trigger for an alignment shift. Each attack on a player character or NPC of good alignment can result in an incremental negative shift.

The consequences of alignment changes can be varied. Attitudes of NPC's and game generated creatures will be the most obvious result. NPC guards in a town of overall good alignment may attack an evil character on sight, and vice versa. Players may be able to detect alignment either automatically (such as by CONing the evil character) or by means of a know alignment ability or spell comparable to those used in tabletop role playing games. Player characters may have a colored aura that can be dimly seen indicating alignment, e.g., a white light that is brighter for each positive point above 100 or a red glow that gets brighter for each point below 0. This aura may only be visible to certain classes (priests or diviners) or only visible at certain times (night, when a moon is out.) Certain spells or abilities may permit a character for limited times to project a false alignment or aura, making an evil character appear good, or vice versa.

Some character classes may have stringent alignment requirements or codes by which class members are expected to act. A paladin, for example, is supposed to be a defender of the weak, not one who preys on the weak. As such, any paladin whose alignment drops below 100 loses his character class and any special abilities it confers, and shifts permanently to another class. The paladin may become an ordinary fighter, or may become a special pariah class (a fallen paladin). It may be possible for the character losing class status to regain it, such as by doing an elaborate quest as penance.

“Faction” or alignment based powers could provide an addition to cafeteria style selection of abilities and skills or improvement of skills through long monotonous repetition (per DAOC trade skills). The effect of some class abilities may be directly based on the alignment score. For example, a cleric can use a blast of faith to dispel undead, the chance of success increases as the alignment score becomes more positive. At certain thresholds, e.g. 500 or −500, characters of certain classes may gain special abilities. Some character classes, such as assassins or necromancers, are based on evil alignments and become more powerful as the player controlling them commits evil acts.

Whether an action adds to or subtracts from alignment should depend on the alignment of the character taking the action. To a good character, attacking an evil creature is considered a good act. However, to a character that is already evil, attacking the same evil creature is considered a mildly evil act (it was done out of spite, not to rid the world of evil.) Unlike good players, evil players will generally receive a negative alignment adjustment even for fighting amongst each other. Thus, these character classes will tend to attract real life player personalities that enjoy attacking other players more or less at random.

Some evil actions may result in automatic setting of alignment to evil regardless of alignment total. Thus, it is not possible to go out and do 100 small (+1) good deeds to build up a large positive score and then commit a heinous crime resulting in −100 to alignment, and have the two effects cancel out. Killing the holy hermit may, for example, reduce alignment to −10 if it was higher than that previously, regardless of how high the alignment score was.

To prevent player manipulation of such a system, it is useful to not provide players with precise information about what their alignment score is; it is a system variable known to players only by the color and brightness of their on-screen aura, for example. The consequences of causing the death of another player may also depend in part on the victim's response to the attack. After being attacked or killed by another player, for example, a player of good or neutral alignment may be offered the choice by the system of pardoning their attacker. If the victim responds “yes” to the question (“You were killed by KnightX. Do you pardon him for his act?”) from the server, then there is no resulting alignment shift or loss of class. This process can leave a way out for rare situations where another player is attacked by accident or based on a misunderstanding.

The alignment shift should, in cases of player versus player combat, depend in part on the difference in power or level between the two players. It is consider bad form even now in games such as DAOC for a high level character to attack a low level character for no reason. This results in a more severe alignment penalty (towards evil) than attacking someone of similar level and power.

Some player abilities according to the invention are gifts from above and can only be earned by doing good (or evil) deeds, or by gaining high favor with a specific faction. Some of these powers may be subtle and hard for the player to notice. After a certain number of “good deeds”, for example, a paladin's wounds heal faster. An evil character gaining a certain faction with the barrow wights might be able to go to the barrows and get a wight as a “pet” or NPC companion. A priest of very high standing with the gods might gain an area effect heal or undead damage aura. A warrior of great renown might by his presence increase the morale (chance to hit) of all grouped with him or nearby, if of similar alignment.

In a preferred embodiment, computer controlled creatures and NPC's have three behavior attributes: alignment, (e.g. good/evil/neutral), attitude, and faction. Attitude determines how a creature reacts when a character of opposing alignment comes within range of it. “Aggressive” means the creature will actively attack any creature of an opposing alignment if it come in range, and will answer calls for help from players or creatures of its faction (see below re calls for help). “Passive” means the creature will fight only in self defense. Faction as in DAOC reflects a social or political group the creature is a member of. Each faction per current games has either a hostile or friendly attitude towards creatures of certain designated other factions. There is an interaction between alignment and faction. All good creatures and players are friendly to one another, but evil creatures commonly war on one another unless under a common leader. Hence evil characters must earn faction with evil creatures in order for them to become neutral and eventually friendly to a player, whereas good players do not have this requirement.

One use of alignment, attitude and faction would be a game command that allows player characters to call for help when they are attacked, such as by another player. A “friendly” faction rating, when applied to an NPC creature or guard, means that the creature will attempt to aid a player that calls for its help. This is true only of creatures with an aggressive (as opposed to passive) attitude. A call for help is a “yell” executed by a player that has a wider radius of effect than the normal aggression radius of a creature. This will work for both evil and good alignments, but to get help an evil character will need to have favorable faction with the evil NPC creature. Thus the orc sentries (evil creatures) at the gates of Uglor's Fortress do not respond when a player character, the evil wizard Cask, is attacked by a good character, paladin Eric. Cask calls for help, but the orcs do not respond because he has not earned a friendly attitude (faction) from their tribe. However, were the paladin to come too close to the orcs, they would attack him.

All aggressive creatures of the same alignment as the caller will answer the call if within range by coming to where the player is and attacking all creatures of opposing alignment they finds there. AI rules will define what a creature summoned in this manner will do in a given situation. For example, the creature may attack the enemy nearest the player calling for help, or may attack an enemy selected at random if more than one is within range. If multiple calls for help are received by a creature, it will respond to the call originating nearest to it at the moment the call is received.

Trading items between players is preferably affected by alignment. Players of different alignments cannot trade with one another. This is to avoid the typical player work around of having good and evil characters on the same user account, and using the good character to go into town to supply items or money to the evil character. This happened with the rudimentary alignment system used in Ultima Online.

In an alignment system using three tiers, good, evil and neutral, neutrality preferably is not designed to be a permanent state for a character to be in, but rather a transitional range between good and evil. A neutral character may be attacked by evil characters, and NPC's will not respond to a call for help from a neutral. Neutral NPC's, on the other hand, are the only ones that will trade with all characters regardless of alignment. Neutral guards may take a “peacekeeping” aggressive attitude towards all alignments, meaning they attack any player that damages another player within their aggression radius, regardless of alignment.

In an alignment based game world where they are likely to be danger zones where a good character is sure to be attacked by evil ones, the game system may permit characters to hire temporary companion NPC's such as mercenaries. These NPC's follow the character for a limited time or for the duration of a game session and attack any character or creature that attacks the character they were hired by. For play balance purposes, the system is likely to impose strict limits on the use of companions and mercenaries. For example, no more than three companions per character, and the companion must be lower level than the character, with special and rare exceptions. Companions could be made active for the current session only and disappear if the player logs off, but timer based companions are preferred, that is, the companion stays for a certain period of real time and then departs. Preferably the companion NPC is programmed to depart if the character hiring it enters a dungeon or similar place of high danger. The system may provide for simple commands to be given to companions, in the manner that pets are handled in DAOC. A companion asked to stay at one spot effectively becomes a guard for that area.

For the most part, MMORPG's do not use collision detection between player characters and/or enemies to block movement. In other words, the presence of a player character or computer controlled enemy does not prevent a character from moving through the other character or enemy as if it were not there. In DAOC, only certain objects such as walls, trees and doors block movement. Full collision detection between player characters would rapidly become frustrating and could be easily abused. However, the lack of collision detection is most felt during large scale combats between groups of players. There is no way to hold a narrow passage and prevent enemies from moving through. The present invention aims to address this by providing a limited form of player vs. player collision detection.

Formations are not new per se in computer games; in games where a single player controls multiple creatures (e.g., Warcraft 3), the player may specify a formation and the controlled creatures will move according to the formation specified. However, formations have not found application in MMORPG's where different players control the animated characters making up the formation.

A “formation” for purposes of the invention could be similar to a DAOC group. It is created by a leader who first specifies the type of formation and possibly the number of slots in it, then invites members. There will be a minimum size which might be as low as 8, more likely 10-12 or higher. Some formations may have a fixed number of slots or a number of slots that varies in even increments. For example, the Napoleonic square might be a minimum of 4 by 4 (4 per side, 10 members), with possible enlargements in units of 4. Some formations may have special properties if everyone in the formation meets the qualification. For example, the shield wall formation is a minimum of 8 characters side by side each using a shield. This gives a large defense bonus.

Formations obviously have a shape, linear, square or wedge being the most common examples. A character that enters the formation loses the ability to move independently of the formation until he or she leaves it by giving that command (e.g., /formation leave). The formation moves as a unit when the formation leader moves. Characters in a formation can still fight and use abilities normally, but there will be a risk that movement of the formation will spoil a spell cast. Formations are primarily intended for fighter types. When a character is invited into a formation and accepts, he or she moves automatically to the next open slot and thereafter moves with the formation until he or she leaves it or dies. If formation members become temporarily mesmerized or paralyzed, it does not break the formation but prevents it from moving.

A formation has a special effect on movement, of both friends and enemies, or optionally just enemies. Between adjacent members of the formation there is an invisible linear barrier that prevents movement through the formation in either direction (or just outside in) as long as the formation is intact and both adjacent members are alive. A hole can be formed when or more formation members are killed.

Optionally, the formation remains intact until a certain percentage of the slots in the formation come open, such as a third, a half, or more. At this point the formation spontaneously dissolves. This minimum does not apply during building of the formation, but only kicks in once the formation reaches the minimum level. New members can be invited into the formation to fill empty slots by the leader or it may be possible to allow characters to join on their own initiative (a command /formation join) would cause the character to enter the nearest formation if any was in range.

Formations can be used for protection of more vulnerable characters who can work from inside the formation. For example, a square while intact forms a fence around clerics or casters standing inside it, preventing them from being attacked directly or by invisible (stealthed) assassins. It is possible to nest formations, i.e. form a smaller square inside of a larger one.

The shape of a formation is inflexible or mostly so (small deviations of a member might be allowed within a limited range from “home” position in the formation) and if one member of it is blocked by terrain, the entire formation will be unable to move. Thus, the size and shape must be chosen so that the formation will fit into available space.

Some specific formations:

| | Number | |
|---|---|---|
| Name | members | Special Abilities |
| Line | 8 or more | Characters form a row and move in tandem |
| | | with leader |
| Square | 12 + 4 * N | Square shape even number of characters |
| | | per side |
| Wedge | 11 + 2 * N | A.k.a, phalanx. If all members are using |
| | | spears or pole arms, all received |
| | | formation damage bonus. |
| Shield Wall | 8 or more | As line, but only shield users may be added. |
| | | Formation receives defensive bonus. |

A “ram team” can be considered another specialized formation. This formation requires the leader to first construct a battering ram from wood with a metal head, a simplified version of the non-portable ram used in DAOC. The size and attack power of the ram varies depending on how much wood was used to make it. The leader then invites members to join the formation and when they do they move to pick up the ram. The formation cannot move until the combined strength of the members matches the weight of the ram. Excess members above the minimum needed may be added. To attack, the ram formation must move back and then forward again at the target. The speed of movement at the time of impact affects the damage done more than what kind of wood the ram is made of, and depends in turn on how many characters are in the formation (alive) and their respective strengths. A player may leave the formation at any time by giving the appropriate command.

Random PvP encounters often match a powerful player character against a weak one, with predictable results. According to the invention, a specific area (arena) is designated where PvP ritual duels are permitted. One player challenges another to a duel, and the other must accept. Both may then enter the arena, where they can fight each other but not anyone else who might be there. Certain classes might suffer a loss of standing or experience from refusing a duel under certain circumstances. Duels may be specified as not to the death, meaning that the duel ends when one player or the other is reduced to 5% health (and gets knocked to the ground in elaborate fashion) and it is not possible to reduce a players health below that level as a result of dueling. Some guilds may adopt this as a condition of entry (you must beat a member in a duel to become a member.)

In a more elaborate version, periodically tournaments are held in which optionally only high or highest ranked PvP players are permitted to enter. Matches are determined by the system based on the highest ranked players present in the holding area, and the players then are allowed a certain amount of time to resolve their duel or be dropped from the tourney. The tourney is by elimination with the winner moving on to a new opponent. The ultimate winner receives a unique prize that cannot be had any other way. An NPC announces the matches and the results, making player betting on the outcome of a match possible.

According to the invention, a balance of power system can be implemented to correct imbalances caused by player fads and exploitations of the inevitable flaws in game balance. The system motivates players to divide evenly between evil and good character types. Certain special abilities or stats are divided by character levels among characters of good and evil alignment. For example if 80% on the players on the server decide to be evil, they share a thinly spread power bonus. The 20% who decide to be good alignment receive four times the power bonus that each evil character receives. This could instead or in addition be implemented through NPC's. If evil characters are in the majority, the places of good have strengthened or additional guards. This also can be done on a character class basis. Thus the most unpopular class receives the highest bonuses, and these bonuses shift as the makeup of active player characters shifts (when everyone makes a wizard, the power bonus for wizards is very low, but improves as some people abandon their wizard characters for other classes.) The balance of power may be based on the total count of active characters, or just who is online at that moment.

Multiple tier server realms according to the invention can provide a more interesting gaming experience not to mention marketing opportunities for the game company seeking to distinguish itself from competitors. In general, according to this aspect of the invention, the servers are classified as low, intermediate and high. A new character starts on the low server and must fulfill certain conditions in order to be allowed on the next higher server. For example, the servers are split up by level so that very high and very low level characters do not mingle. Upon reaching a certain level, the character graduates on to the next server or game world and can no longer return to the prior world. Example: First world covers characters of levels 1-20. Upon reaching level 20 (or its equivalent in total skill points, if that system is used), the player can no longer gain experience or improve in abilities on that server. He must report to a one-way gate that transfers the character data to a new server.

There may be basic differences between the servers. For example, the first server is essentially a proving ground not unlike the current DAOC environment, mainly a static world with respawning enemies. If a player dies, he or she is reincarnated with little or no penalty. On the second server, the environment is more competitive. Players may level without limit, but to leave the server for the third and final server requires completion of a difficult quest in competition with other players or teams/groups of players. Only one group can win at a time, after which the quest is reset with different parameters and must be started again. In the alternative, there are a fixed number of player characters per realm or team, and all start the intermediate server at the same time at the same level. Guilds may ask to enter teams in groups. A power struggle ensues and the group (evil, good, neutral) that is leading in control of artifacts of power at the end of the time limit (e.g., the conjunction of the suns) earns the right to move on. The other two teams must try again in the next cycle.

The third and final server is a place of adventure for high level characters only that have prevailed on the second server. The monthly fee for this world is higher because it involves the best, most creative content and uses human controlled NPC's as described above. There are no “newbies” here, and the quality of game play is at the highest level on both the server and player sides. Thus, the multiple tier servers preferably differ not only in that a character must meet the conditions to move from one to the next, but also in that progressively better game content is provided in the higher level servers. The highest level server may indeed be one wherein human-run NPC's are used as discussed above.

DAOC is notorious for its tendency to produce PvP battles which are often very one sided, with one character winning because it is much more powerful than the other, or one team or characters defeating another for the same reason. According to another aspect of the invention, special PvP areas are created wherein the game system imposes limits both on the power of the players that are permitted to enter (e.g., their level) and the number of players that can enter. The result may be termed a “mini-battleground”.

In this example to which DAOC rules would apply, a series of miniature PvP areas are provided, one area for each 5 level bracket from 6-10, 11-15, 16-20 and so on up to 46-50. The maps for each area would be smaller than a full DAOC zone. Some could be dungeon levels; indeed, all of the areas could be different parts of one large underground zone with different points of arrival depending on player level. It might be possible for players in one area to see or even use long range attacks on players in another area standing in the wrong spot (as on the other side of a deep chasm), but it is not possible to get from one area to another.

The zone entrance in each realm could have a fixed appearance and location similar to the entrances to the Darkness Falls dungeon in DAOC, but with different rules of entry. When a character enters, he or she is sent to the area appropriate to the character's level. If there is more than one possible area, you are sent to the one with the most players from your realm currently in it. The areas are open to all realms at all times, but no more than 8 players per realm are allowed in any one area at a time. Broadcast chat is enabled for the entire area, so there is no need for making a chat group. Optionally, all players who enter automatically join the group there (“auto-grouping”).

An NPC standing near the arrival point knows whether any enemy players are present in the area, and will tell a player character if asked, even giving an indication of how many. Enemies stealthed at the time the question is asked might not count towards the total. If a player logs off while in the mini-battleground, the character is returned to the outside entrance. As a result, little or no time is spent looking for a group of other players to game with, or in trying to join a chat group. The player can find out right away if there is no one from an enemy realm there to fight, instead of running around randomly in empty halls or over empty terrain. The areas are not huge in size, hence not a lot of time is spent running around large expanses of empty terrain. Level limits are in place and no “zergs” are possible due to the one group from each realm per area limit.

A series of different maps are provided for these areas. One area for example could be a maze of narrow tunnels. Another would be a large open cavern filled with mist so that visibility is poor. Another is a series of halls with large pillars lacking any regular creatures (“mobs”), but with a rare spawn of undead that patrol the halls. Another is vertical, essentially a large stair well with the realm entrances at different heights.

Preferably motivation in to go to these battlegrounds is provided beyond merely seeking PvP experience. There are many possibilities. For example, each area has a minor relic in it. The relic can be taken from its neutral resting place to one of three altars near the area entrance for each realm. There are NPC guards for the altars/entrances, but not many. The realm holding the majority of these minor relics receives a global bonus of some kind, such as a realm wide experience bonus, or a boost to the level of NPC guards for that realm. Hence even if there are no enemies present, there is reason for a group from a realm to go in to get the relic and drag it over to their end of the dungeon. It also allows low level characters to make a small contribution to the realm versus realm war effort. Optionally, the minor relics do not remain permanently in place. If the same realm has held a relic for more than a certain number of days (such as a week), it reverts back to its neutral site where it is once again guarded by mobs.

Each miniature battleground area can further have four entrances/exits, three for the realms, and a fourth one that leads to an underground city of an NPC race (e.g., the deep gnomes.) Exceptional goods and materials are for sale in the underground city at reduced prices, and/or merchant buy back prices for player made items are higher than normal. If the mini-battlegrounds are parts of one large zone with different arrival points depending on level, then the underground city can be a common central area open to all areas by going down one-way steps. In the event such battlegrounds become very popular and players become frustrated trying to get in, overflow area(s) are provided to which players are transported in the area they would normally be taken to is full. In an overflow area, there is no limit on the number of players, and the permitted level range is broadened.

The level permitted to enter a mini-battleground need not be fixed in advance, but instead determined based on the characters already inside the mini-battleground. Thus, if the area is empty anyone could enter; otherwise a character must be within 3 levels of the average level of all characters inside in order to enter.

Monitoring of the number of players in a special area may be carried out for a larger battleground such as a PvP dungeon that does not have a level limit, but does limit access in a manner that equalizes the members of opposing realms or alignments present. In the case of DAOC, the number of players of each realm in the area is monitored, and access is based on a rule that keeps the numbers roughly equal: the entrance to the PvP dungeon for a realm is closed if the number of players already in the dungeon from that realm is more than X greater than the number of players in that dungeon from the realm with the fewest players inside, where X is 1 or more. For example if X=8 and Albion has 60 characters inside, Midgard has 57, and Hibernia has 38, then the PvP dungeon is only open to Hibernia. If Hibernia instead had 59, then the dungeon is open to all three realms. If the Hibernia total is 50, the PvP dungeon is closed to Albion but open to both Midgard and Hibernia.

In a game such as DAOC which pits players of one realm against those of another, an RvR quest may be provided. For this purpose an NPC gives any player meeting the minimum level requirement a quest. The quest is selected at random from a list of possible quests and possibly sublists of variations within each quest. It has a set time limit, and expires at the end of the time limit, after which a new quest is offered. During a given time slot, the quest is the same for anyone who gets it. One example is a castle capture quest. The NPC asks all who come to him to band together and capture a certain castle currently held by an opposing realm. Anyone who has the quest at the time the castle is captured and who is “on the scene” i.e. the character is within the castle map zone, gets the reward by stopping in at the NPC. The reward could be magic items, gold, realm points, bounty points, special victory banner for player house, or the like.

There may also be special world events associated with the quest. For example, the NPC has learned that there is a plague in Midgard, and that certain of its frontier guards have returned to their homes temporarily, leaving the keep defenses in a weakened state. Only half the normal number of guards spawn for the duration of the quest period. Or, due to a powerful spell cast by the home realm's wizards, the bonuses granted by relics of all realms have been temporarily neutralized.

“Relics” in DAOC are special items belonging to a realm, not an individual player, that confer global bonuses on all players of the owning realm. In DAOC, one of the objects of RvR combat is to capture an opposing realms relics. However, on some servers, especially ones where there is a population imbalance between realms, a realm may essentially give up on its relics, allowing them to be captured and kept by the enemy realm indefinitely. A special relic quest according to the invention may be triggered by the length of time a relic has been in enemy hands. Thus the “Get Merlin's Staff” quest doesn't become available to the list until the staff has been missing from its place for more than two weeks real time.

Player decadence or unwillingness to participate as the game designers intended may also be a factor when a realm makes no effort to recover its relics. According to the invention, the game system can intervene in such a situation by forcing players to work together to retake the relics or face consequences, such as progressively decreasing realm point awards for defeating players of enemy realms, or inactivation of easy transport to places other than where the missing relics are located. Some human moderation of global penalties may be needed if it appears that the realm is simple too weak to recapture its relics despite best efforts by its players.

The ability of one character to become invisible relative to others has a high impact on PvP combat in games such as DAOC. However DAOC's version of invisibility is termed “stealth” and its use is severely limited to certain spy-like classes. According to the invention, characters with a “stealth” ability that is supposed to reflect skill in hiding are limited by terrain features. Hiding using the stealth ability is limited to certain locations where there is at least the hint of a rational basis for being able to hide there, e.g., in an area where the lighting is poor, near a tree or boulder, in a corner or along a wall. Even a master spy is not permitted to stand invisibly at noon in the middle of a grassy plain so that he can attack a thinly clad wizard running by. In addition, a limited form of stealth ability is made available to all classes, specifically that anyone can hide in certain locations, such as behind objects or near walls, but becomes visible when that character moves or takes an action. Only classes with elevated stealth skill can remain hidden (invisible on the screen's of opposing players) while moving or starting an attack.

Other than where human control or moderation is expressly mentioned, the foregoing aspects of the invention are implemented by means of appropriate software and hardware, using for example game software installed on local player PC's in combination with server software communicating with players PC's through the Internet an running on a server operated by the game provider. This server-based structure is in use now in current MMORPG's.

Many different improvements to MMORPG's have been described herein. Except for those which represent mutually exclusive alternatives, a MMORPG according to the invention should include as many of the described features as possible to the extent compatible, in order to provide more variety and less predictability to such games. However, each described improvement can also be implemented separately.

1. In a MMORPG system including a server running game control software operating a persistent game world in which players move animated characters using commands transmitted to the server through a network, wherein the game control software includes an improvement selected from the group consisting of
(A) at least one common persistent area in which player controlled characters can move and interact, one or more non-persistent areas which appear when at least one player character enters them from the common area and disappear or are reset when a completion condition is met, and at least one entry area where a player controlled character can move from the common area to the non-persistent area if an entry condition is satisfied;
(B) the game control software creates a screen map display that reveals a hidden terrain feature when a player controlled character approaches it to within a certain distance that is shorter than the distance required to see other non-hidden terrain features,
(C) multiple servers running multiple game control system software are employed wherein players must complete entry qualifications on a first, entry server before being allowed to play on a second, advanced server by transfer of the character from the first server to the second;
(D) the game control software maintains a player character alignment attribute that changes in response to actions taken by a player in accordance with a defined standard, and which causes one or more game consequences when a player's alignment changes by more than a predetermined amount, which consequences include changes in abilities available to the character that has changed alignment;
(E) the game control software creates a game world map that includes at least one common persistent area in which player controlled characters can move and interact, at least one limited access area which can only be entered by moving a player controlled character from the common area to the limited access area from an entry location in the common area, wherein the entry location including its player-viewable graphic representation moves from one common area location to another when a trigger event has occurred;
(F) the game control software accesses multiple databases of facts known to non-player characters controlled by the game control software, which databases are classified by how widely known the facts are within the game world, and the game control software further has access to an NPC database designating which fact databases are accessed when a player character requests information concerning a fact from a non-player character, whereby a player can gather information concerning a topic by asking different non-player characters concerning it and receiving replies that vary depending on which fact databases the non-player character questioned has access to;
(G) the game control software generates encounter areas for player characters to discover by selecting features of the encounter from one or more databases containing possible encounter features, and then rendering the selected features at a location in the game world;
(H) the game control software permits players to create temporary multiplayer formations which obstruct player movement through or between members of the formation;
(I) the game control software spawns some game world objects on a recurring basis in order to maintain a substantially steady supply of such objects in a target map area, and spawns other objects as one time spawns; and
(J) a sound system whereby musical tones programmed by a player whose character is using a musical instrument in game are reproduced at other player's computers which other players are within range of the sound in the game world.

2. The MMORPG game system of claim 1, wherein the improvement is (A).

3. The MMORPG game system of claim 1, wherein the improvement is (B).

4. The MMORPG game system of claim 1, wherein the improvement is (C).

5. The MMORPG game system of claim 1, wherein the improvement is (D).

6. The MMORPG game system of claim 1, wherein the improvement is (E).

7. The MMORPG game system of claim 1, wherein the improvement is (F).

8. The MMORPG game system of claim 1, wherein the improvement is (G).

9. The MMORPG game system of claim 1, wherein the improvement is (H).

10. The MMORPG game system of claim 1, wherein the improvement is (I).

11. The MMORPG game system of claim 1, wherein the improvement is (I).

12. The MMORPG game system of claim 6, wherein the entry location moves to a destination determined by an algorithm such that players cannot predict in advance where the entry location will appear.

13. The MMORPG game system of claim 3, wherein the hidden terrain feature is not revealed unless the player character meets a predetermined condition in addition to minimum distance.

14 The MMORPG game system of claim 1, wherein the system contains at least two of the improvements (A)-(J).

15 The MMORPG game system of claim 1, wherein the system contains at least three of the improvements (A)-(J).
